(19) United States
(12) Patent Application Publication
(10) Pub. No.: US 2016/0334208 A1
(43) Pub. Date: Nov. 17, 2016

(54) OVERLAY MARK PATTERN AND METHOD OF MEASURING OVERLAY

(71) Applicant: UNITED MICROELECTRONICS CORP., Hsin-Chu City (TW)

(72) Inventors: En-Chiuan Liou, Tainan City (TW); Yu-Cheng Tung, Kaohsiung City (TW); Yi-Jing Wang, Tainan City (TW)

(21) Appl. No.: 14/737,475

(22) Filed: Jun. 11, 2015

(30) Foreign Application Priority Data
May 12, 2015 (TW) 104114964

(51) Int. Cl. G01B 11/26

(52) U.S. Cl. CPC G01B 11/26

(57) ABSTRACT

The present invention provides an overlay mark information, including at least a pair of first overlay mark patterns disposed in a first layer, each first overlay mark pattern consisting of a plurality of first mark units arranged along a first direction, where each first mark unit includes at least one first pattern and at least one second pattern, and the dimension of the first pattern is different from the dimension of the second pattern. The overlay mark information also includes at least a pair of second overlay patterns disposed in the first layer, each second overlay mark pattern consisting of a plurality of second mark units arranged along the first direction, where the pattern of each first mark unit is the same as the pattern of each second mark unit after 180 degrees rotated.

### BACKGROUND OF THE INVENTION

1. Field of the Invention

The present invention relates generally to the field of semiconductor manufacturing processes, and more particularly to a method of measuring overlay in photolithographic processes.

2. Description of the Prior Art

Photolithography is an essential step in semiconductor manufacturing processes, through which the pattern of integrated circuits maybe transferred from photomasks to semiconductor chips. Generally, a design layout of integrated circuit provided by an IC design house may be divided into several layers of design layouts after it is received by the semiconductor manufacturing company. These design layouts may be then fabricated on the corresponding transparent plates to thereby form photomasks with desired layouts. The layout of each of the photomasks may be respectively transferred to a photoresist layer on the chip through suitable photolithographic process. Afterwards, other suitable processes, such as etching, deposition, doping, CMP, thermal/annealing and so forth may be carried out in order to obtain required semiconductor devices.

Recently, the measurement of the overlay between two or more successive layers becomes more and more important along with the continuous miniaturization in integrated circuits. For instance, through vias and contacts are often used to electrically connect interconnections in different layers to one another. Because the interconnections, the through vias and/or the contacts are generally disposed in different layers, a process of overlay measurement needs to be carried out during each of the corresponding photolithographic processes so as to ensure the minimum shift between successive layers.

However, the current overlay measurement still has some drawbacks. For example, due to measurement deviation, the measured values of relative positions between successive layers often fail to reflect their real positions. Therefore, the measurement results often include overlay error.

Accordingly, there is a need to provide an improved method of correcting overlay error so as to increase the accuracy of the measurement results.

### SUMMARY OF THE INVENTION

The present invention provides an overlay mark, comprising at least a pair of first overlay patterns disposed within a first layer, each first overlay pattern consisting of a plurality of first mark units and arranged along a first direction, each first mark unit including a first pattern and at least one second pattern, the first pattern and the second pattern having different dimensions, and at least a pair of second overlay patterns disposed within the first layer, each second overlay pattern consisting of a plurality of second mark units and arranged along the first direction, wherein the pattern of each second mark unit is the same as the pattern of each first mark unit after rotating 180 degrees.

The present invention further provides a method for correcting overlay errors, comprising: firstly, an overlay mark on a substrate is detected, so as to generate an overlay mark information, wherein the overlay mark information comprises: at least a pair of first overlay patterns disposed within a first layer, each first overlay pattern consisting of a plurality of first mark units and arranged along a first direction, each first mark unit including a first pattern and at least one second pattern, the first pattern and the second pattern having different dimensions, and at least a pair of second overlay patterns disposed within the first layer, each second overlay pattern consisting of a plurality of second mark units and arranged along the first direction, wherein the pattern of each second mark unit is the same as the pattern of each first mark unit after rotating 180 degrees. Next, an overlay mark information is calculated, so as to obtain a deviation value AB between the first overlay pattern and the second overlay pattern, and the deviation value AB is used to calculate a bias value, wherein the bias value is equal to AB/2.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing an overlay mark on a photomask according to the first preferred embodiment of the present invention.

FIG. 2 shows the patterns on the first photomask.

FIG. 3 shows the patterns on the second photomask.

FIG. 4 shows the schematic cross section diagram of a substrate having the first, the second and the third overlay pattern according to the first preferred embodiment of the present invention.

FIG. 4A shows the schematic cross section diagram of a substrate according to another embodiment of the present invention.

FIG. 5 shows the overlay mark information obtained through an inspection process.

FIG. 6 is a schematic diagram showing an overlay mark on a photomask according to the second preferred embodiment of the present invention.

FIG. 7 is a schematic diagram showing an overlay mark on a photomask according to the third preferred embodiment of the present invention.

FIG. 8 is a schematic diagram showing an overlay mark on a photomask according to the fourth preferred embodiment of the present invention.

### DETAILED DESCRIPTION

In the following description, numerous specific details are given to provide a thorough understanding of the invention. It will, however, be apparent to one skilled in the art (note: of ordinary skill in the art) that the invention may be practiced without these specific details. Furthermore, some well-known system configurations and process steps are not disclosed in detail, as these should be well-known to those skilled in the art.

Likewise, the drawings showing embodiments of the apparatus are not to scale and some dimensions are exaggerated for clarity of presentation. Also, where multiple embodiments are disclosed and described as having some features in common, like or similar features will usually be described with same reference numerals for ease of illustration and description thereof.

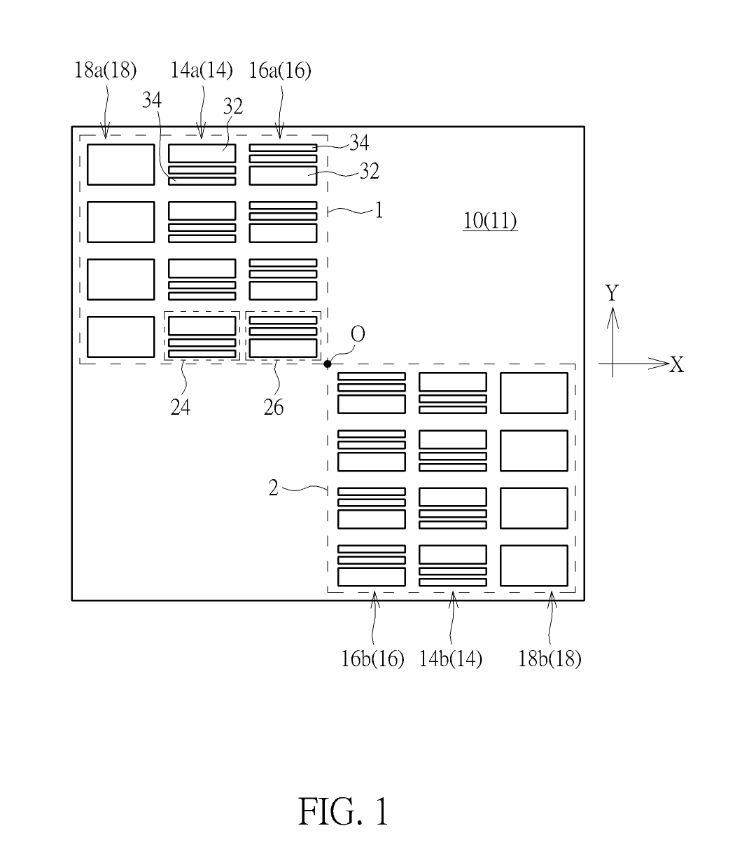

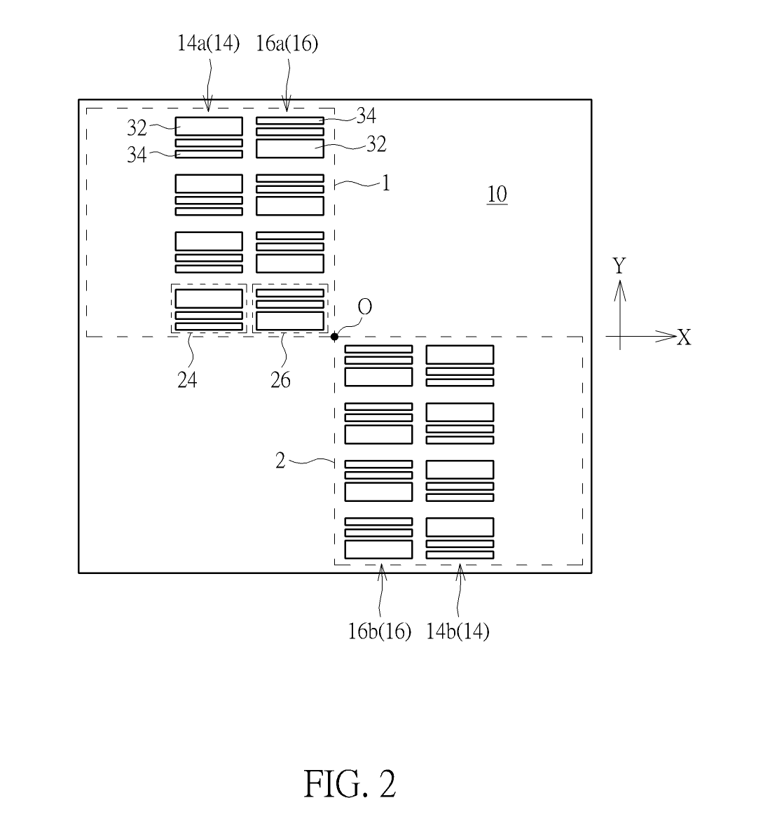

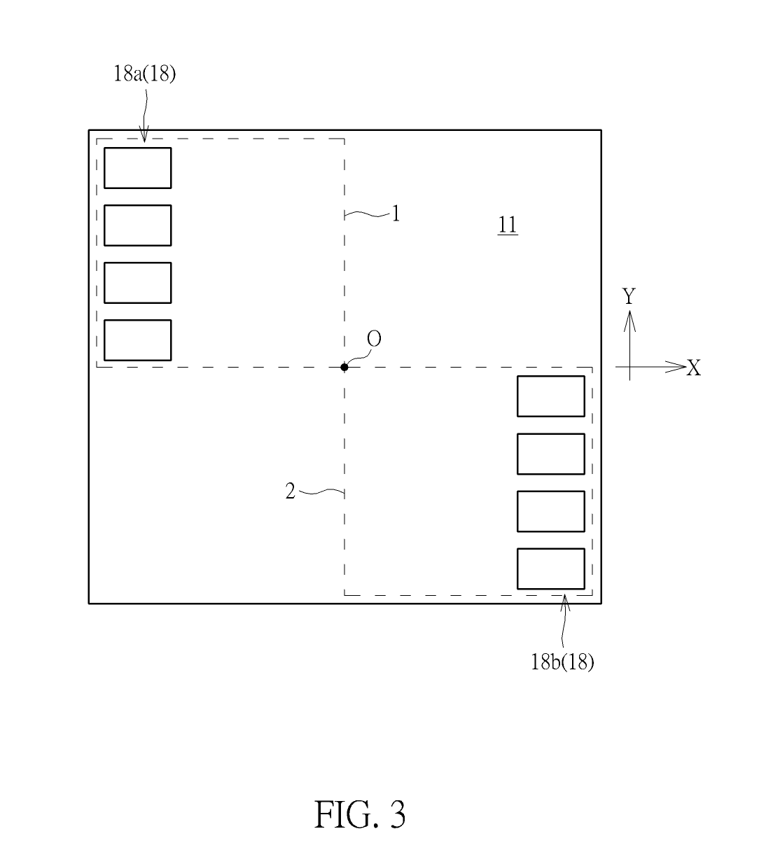

FIG. 1 is a schematic diagram showing an overlay mark on a photomask according to one embodiment of the present invention. As shown in FIG. 1, an overlay mark 12 comprises at least a pair of first mark arrays 14 (labeled as 14a and 14b respectively), a pair of second mark arrays 16 (labeled as 16a and 16b respectively), and preferably further comprises a pair of third mark arrays 18 (labeled as 18a and 18b respectively). The first mark arrays 14a, 14b are disposed on a first photomask 10, and the second mark arrays 16a, 16b are also disposed on the first photomask 10. The third mark arrays 18a, 18b are disposed on a second photomask 11. The first, the second and the third mark arrays 14, 16, 18 are arranged along a first direction (such as Y-axis). Please refer to FIG. 2 and FIG. 3, which show the patterns on the first photomask 10 and on the second photomask 11 respectively. The patterns on the first photomask 10 and on the second photomask 11 compose the overlay mark shown in FIG. 1.

Besides, in this embodiment, each first mark array 14 consists of a plurality of the first mark units 24, each first mark unit 24 arranged along a first direction (such as Y-axis), and each first mark unit 24 consists of at least one first pattern 32 and at least one second pattern 34. Preferably, the first pattern 32 and the second pattern 34 have different dimensions. For example, the first pattern 32 such as a rectangle shaped structure, and the second pattern 34 are grid structures and are arranged parallel to each other. Each second mark array 16 consists of a plurality of the second mark units 26 and is arranged along the first direction (such as Y-axis), the pattern of each second mark unit 26 is the same as the pattern of each first mark unit 24 after rotating 180 degrees (on XY plane). More precisely, in this embodiment, each first mark unit 24 consists of at least one first pattern 32 and at least one second pattern 34, and on XY plane, the first pattern 32 is disposed above the second pattern 34 (towards +Y axis direction), and each second mark unit 26 also consists of at least one first pattern 32 and at least one second pattern 34, but the first pattern 32 is disposed under the second pattern 34 (towards −Y axis direction).

It is noteworthy that in this embodiment, the first mark arrays 14a, 14b, the second mark arrays 16a, 16b and the third mark array 18a, 18b are disposed within different regions of the overlay mark 12. For example, the first region 1 is disposed on the top left corner of FIG. 1 and the second region 2 is disposed on the bottom right corner. Besides, the first region 1 and the second region 2 are not limited to being disposed on the top left corner and the bottom right corner respectively, and it can be adjusted according to actual requirements. Preferably, an origin point O on the photomask is defined as the center, the first region 1 and the second region 2 are arranged symmetrically.

Generally, the overlay mark 12 is disposed within the scribe line of a wafer, used for confirming whether the overlay shifting between different patterns in different levels occurs or not in the following steps. More precisely, the first and the second mark arrays 14, 16 can be transformed to a same level of a substrate, whereas the third mark arrays 18 are transformed to another level of the substrate. By measuring the relative position of the first, the second and the third mark arrays on the substrate, the overlay accuracy of the circuit layout pattern can be confirmed.

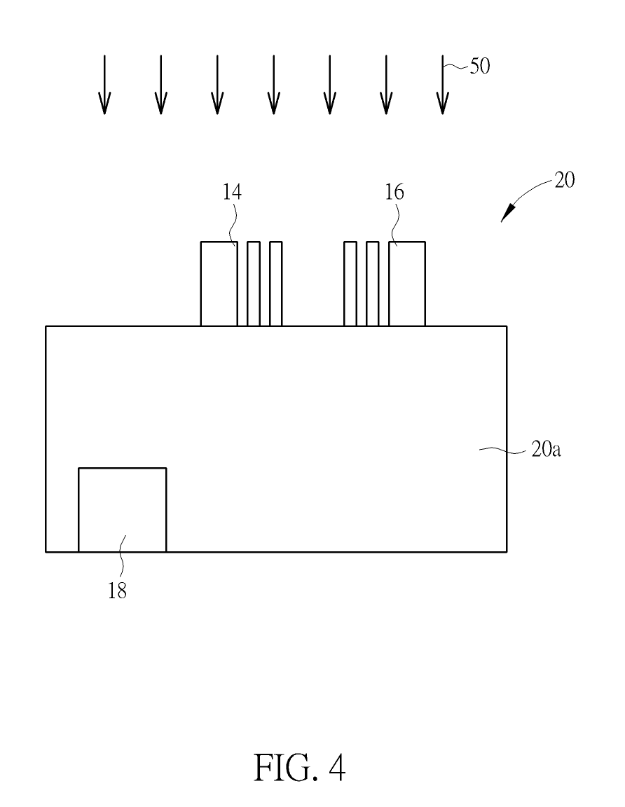

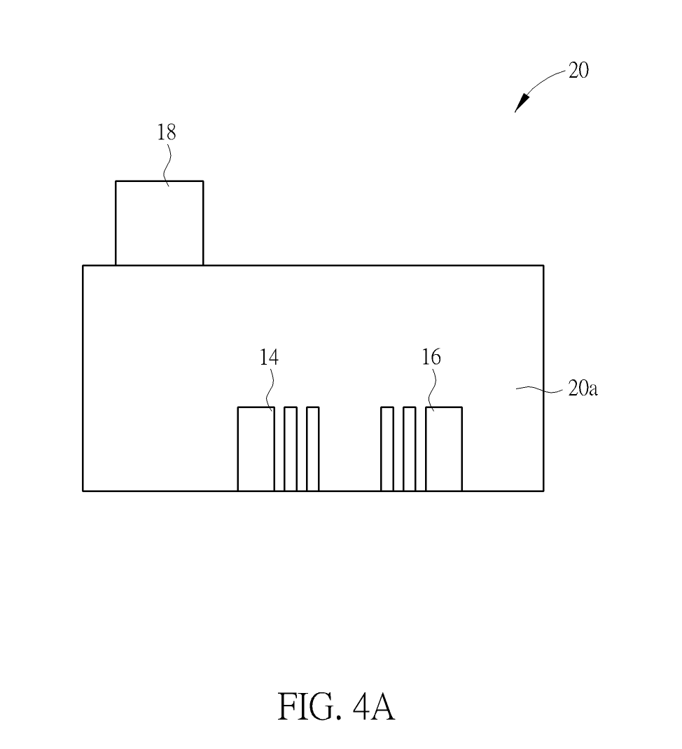

Please refer to FIG. 4, which shows the structure that includes the first and the second mark arrays being transformed into a same level of a substrate, and the third mark arrays being transformed into another level of the substrate. It is noteworthy that FIG. 4 only illustrates the relative position of each mark pattern, but FIG. 4 is not the cross section diagram of FIG. 1. As shown in FIG. 4, after suitable processes such as photolithography, etching, deposition, thermal/annealing process and planarization are performed, the third mark arrays 18 on the second photomask 11 can be transformed into the substrate 20, and afterwards, the first mark arrays 14 and the second mark arrays 16 are transformed into the substrate 20 in sequence. The transformed patterns including the third overlay pattern 48, the first overlay pattern 44 and the second overlay pattern 46 correspond to the third mark arrays 18, the first mark arrays 14 and the second mark arrays 16 respectively. The third overlay pattern 48 disposed within a bottom layer 20a, the first overlay pattern 44 and the second overlay pattern 46 are disposed above the bottom layer 20a. In other words, both the first overlay pattern 44 and the second overlay pattern 46 are disposed on a same level, and after another layer (not shown) is then formed on the bottom layer 20a in the following steps. The first overlay pattern 44 and the second overlay pattern 46 will be disposed within a same layer. More precisely, using the photomask and manufacturing methods mentioned above, the third overlay pattern 48 formed in the scribe line of the substrate 20 can be used for correcting the position of a gate structure (not shown) within the active area, and the first overlay pattern 44 and the second overlay pattern 46 are used for correcting the position of the contact structures. Therefore, the relative positions of the gate structure and the contact structures can be decided by measuring the relative shifting between the first overlay pattern 44, the second overlay pattern 46 and the third overlay pattern 48. It should be noted that the first, the second and the third overlay patterns disclosed above may also be formed on another suitable substrate different from the semiconductor substrate. For example, they may be formed on a plastic substrate, glass substrate and so forth. In this embodiment, the bottom layer 20a may be a bottom interlayer dielectric (ILD). The first overlay pattern 44 and the second overlay pattern 46 are the contact structures or the photoresist layer within the correcting region. In addition, in another embodiment of the present invention, as shown in FIG. 4A, the first mark arrays 14 and the second mark arrays 16 are transformed into the substrate 20 firstly, and the third mark arrays 18 are then transformed into the substrate 20. Therefore, the first overlay pattern 44 and the second overlay pattern 46 are within the bottom layer 20a, and the third overlay pattern 48 disposed above the bottom layer 20a. It should also be within the scope of the present invention. In order to simplify the description, the following paragraphs still take FIG. 4 as an example.

After the structure shown in FIG. 4 is obtained, an inspection process 50 can be performed on the first overlay pattern 44, the second overlay pattern 46 and the third overlay pattern 48 on the substrate 20, such as the diffraction based overly (DBO) inspection process or the image based overlay (IBO) inspection process, so as to generate the corresponding overlay mark information. And it will be described more detail below.

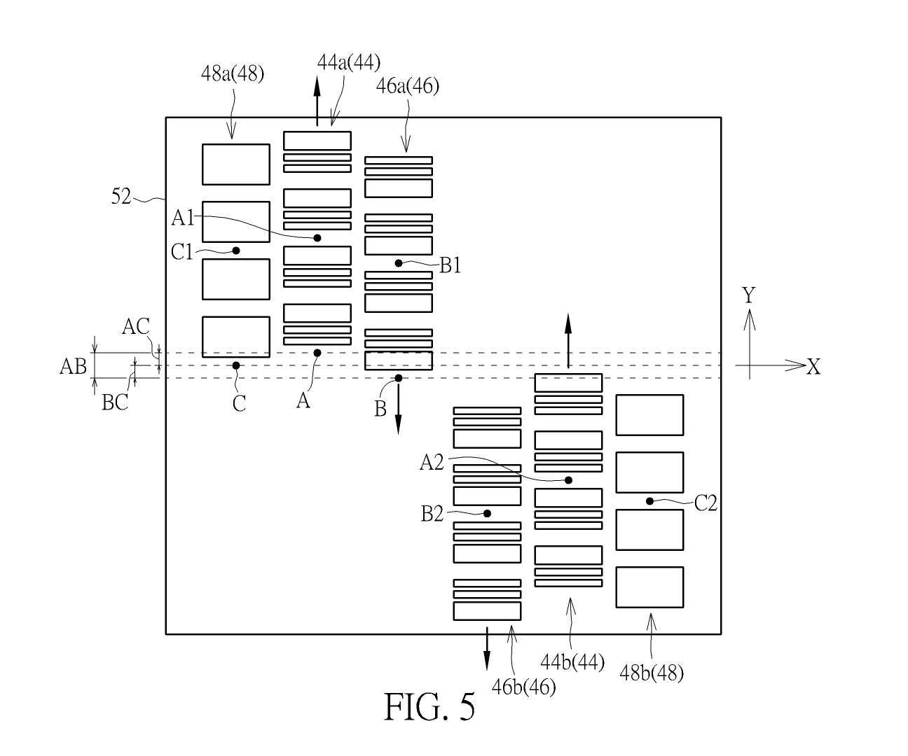

FIG. 5 is a schematic diagram showing overlay mark information about the first overlay pattern, the second pattern and the third overlay pattern. After the inspection process 50 is performed, the overlay mark information 52 shown in FIG. 5 is generated. In this case, the overlay mark information 52 may be an image file including the first overlay patterns 44a, 44b, the second overlay patterns 46a, 46b and the third overlay patterns 48a, 48b, which may be stored in an electronic form in a computer readable medium. Generally, the relative shift between the circuit patterns in successive layers may be determined by measuring and calculating the relative positions of the central positions of the first overlay patterns 44a, 44b, the second overlay patterns 46a, 46b and the third overlay patterns 48a, 48b.

The method will described here: since each first mark unit 24 of the present invention consists of the first pattern 32 and the second pattern 34, when the inspection 50 is performed, so as to form the overlay mark information 52, some errors may occur (such as caused by the refractive index difference of the dielectric layer), and that will cause each first mark unit 24 within the first region 1 to shift (or have an offset), due to the first pattern 32 and the second pattern 34 having different dimensions or shapes. Therefore the upper side and the lower side of each first mark unit 24 have different boundary conditions. In this way, the inspected first overlay pattern 44a may shift toward a specific and fixed direction (such as the +Y axis direction). Similarly, the inspected first overlay pattern 44b within the second region 2 may shift toward the same direction (such as the +Y axis direction). In addition, since the pattern of each second mark array 16 is the same as the pattern of each first mark array 14 after rotating 180 degrees, if both the first overlay patterns 44a, 44b are shifted toward positive Y axis direction, then the second overlay patterns 46a, 46b should be shifted toward the negative Y axis direction. The arrows shown in FIG. 5 illustrate the shifting direction. It is noteworthy that the arrows of FIG. 5 only show one possible situation of the present invention, and the actual shifting direction may be different from the arrows shown in FIG. 5, but the condition of the first overlay pattern 44 and the second overlay pattern 46 are shifted toward opposite directions should still be satisfied.

Afterwards, according to the overlay mark information 52, each central position of the first overlay patterns 44, the second overlay patterns 46 and the third overlay patterns 48 can be calculated, and so as to determinate the bias value (the shifted value) between each central position. It is noteworthy that the patterns on the photomasks 10, 11 (including the first mark arrays 14, the second mark arrays 16 and the third mark arrays 18) have not had any shift between each other. Therefore, the central position of the first mark arrays 14, the second mark arrays 16 and the third mark arrays 18 should be disposed on a same horizontal level. However, as mentioned above, while the inspection process 50 is performed to generate the overlay mark information 52, because of inherent detection error in detection tool, such as errors induced by the difference in the refractive index of dielectric layers, the measurement result of the first overlay patterns 44, the second overlay patterns 46 and the third overlay patterns 48 are often deviated from the real situation. For example, with the overlay mark information 52, within the first region 1, the central position of the first overlay pattern 44a is labeled as A1, the central position of the second overlay pattern 46a is labeled as B1, the central position of the third overlay pattern 48a is labeled as C1; within the second region 2, the central position of the first overlay pattern 44b is labeled as A2, the central position of the second overlay pattern 46b is labeled as B2, and the central position of the third overlay pattern 48b is labeled as C2. In the present invention, the central position A can be obtained by calculating the average of the central position A1 and A2; the central position B can be obtained by calculating the average of the central position B1 and B2; and the central position C can be obtained by calculating the average of the central position C1 and C2. Next, the vertical distances between the central position A, the central position B and the central position C along Y axis are measured to obtain the distances AB, BC and AC.

Afterwards, a bias value can be calculated, wherein:

bias value=(AB/2) equation 1

Finally, the bias value mentioned above is outputted after the bias value is calculated, wherein the bias value stands for the offset between the first overlay patterns 44 and the second overlay patterns 46 in the overlay mark information 52. Since the first overlay patterns 44 are transformed by the first mark array 14, the second overlay patterns 46 are transformed by the second mark array 16. In addition, the pattern of the first mark array 14 is the same as the pattern of the second mark array 16 after rotating 180 degrees. Therefore, one key feature of the present invention is that two patterns having opposite arrangement directions are formed on a same level of the semiconductor substrate. These two patterns will shift toward opposite directions while some errors occur during the inspection process, thereby calculating the shifted value (bias value) between the two patterns can help to correct the errors caused by different boundary conditions, or to make an alert notice when the error is too large. More precisely, a specific value can be set at beginning of the method of the present invention, and after the bias value is outputted, a process for judging whether the bias value is larger than a specific value or smaller than the specific value is performed, if the bias value is larger than the specific value that decided by the user, at least one of the manufacturing processes during the present invention (such as one of the photolithography, etching, deposition, thermal/annealing process and planarization process) will be stopped or checked.

In summary, the present invention provides a method for measuring overlay, comprising the following steps: (1) a target pattern having features is identified to be printed in a single layer of an integrated circuit device; (2) data for a pair of first overlay patterns is defined, wherein each first overlay pattern consisting of a plurality of first mark units and being arranged along a first direction, each first mark unit including a first pattern and at least one second pattern, the first pattern and the second pattern having different dimensions; (3) data for a pair of second overlay patterns is defined, wherein each second overlay pattern consisting of a plurality of second mark units and being arranged along the first direction, wherein the pattern of each second mark unit is the same as the pattern of each first mark unit after rotating 180 degrees; (4) the data for the first and second overlay patterns is calculated for respectively causing portions of the target pattern; (5) a deviation value AB between the first overlay pattern and the second overlay pattern is determined, wherein deviation value AB is the distance between a central position of the first overlay pattern and a central position of the second overlay pattern; and (6) using the deviation value AB to calculate a bias value, wherein the bias value is equal to AB/2.

In addition, in one embodiment of the present invention, the first overlay patterns mentioned above is formed through a first exposure process, and the second overlay patterns is formed through a second exposure process. And further comprising the following steps: (1) outputting the bias value after the bias value is calculated; (2) performing a process for judging whether the bias value is larger than a specific value or smaller than the specific value; and (3) after the process for judging the bias value is performed, further comprising checking or stopping at least one of the photolithography, etching, deposition, thermal/annealing process and planarization tools while the bias value is larger than the specific value.

It is noteworthy that in this embodiment, within the first region 1, the first overlay pattern 44a is disposed on left side (negative X axis direction) of the second overlay pattern 46a; and within the second region 2, the first overlay pattern 44b is disposed on the right side (positive X axis direction) of the second overlay pattern 46b. Under this arrangement, the first overlay pattern 44a pairs with the first overlay pattern 44b, thereby having a central position A, since the first overlay pattern 44a and the first overlay pattern 44b are shifted toward the same direction, the central position A can be obtained more precisely; similarly, the second overlay pattern 46a pairs with the second overlay pattern 46b, since the second overlay pattern 46a and the second overlay pattern 46b are shifted toward the same direction, a central position B can be obtained more precisely, thereby improving the accuracy while calculating the bias value mentioned above.

Besides, a real overlay value can be decided by measuring the distances AC and BC, wherein:

real overlay value=the average of(AC+BC) equation 2

Preferably, in order to obtain the average of AC and BC, (AC+BC) may be divided by a certain weight, such as divided by 2, and therefore:

real overlay value=(AC+BC)/2 equation 3

Since the third overlay pattern 48 and the first overlay pattern 44 are disposed on different levels, the third overlay pattern 48 and the second overlay pattern 46 are disposed on different levels too. The real overlay value mentioned above is used for correcting the offset value between different levels, or to eliminate the errors caused by the refractive index difference or the off axis illumination, and thereby improving the accuracy of the overlay measurement.

For the sake of clarity, the central positions of the mark patterns may be used as reference points for measuring the relative shift between mark patterns in different layers. However, there may be another way for measuring the relative shift between mark patterns in different layers according to another embodiment of the present invention. For example, the measurement may be carried out by using a diffraction tool to determine diffraction orders of the first overlay patterns, the second overlay patterns and the third overlay patterns. The diffraction orders may be further calculated to thereby determine the relative shift between the overlay patterns in different layers. It should be noted that, in either way, the offset value has to be applied to compensate the deviation value so as to generate the corrected deviation value.

The following paragraphs will describe other preferred embodiments of the present invention. In order to simplify the description, the following paragraphs only describes the patterns on the photomasks. The method for calculating the bias value and the real overlay value are the same as the method mentioned above and will not be redundantly described here.

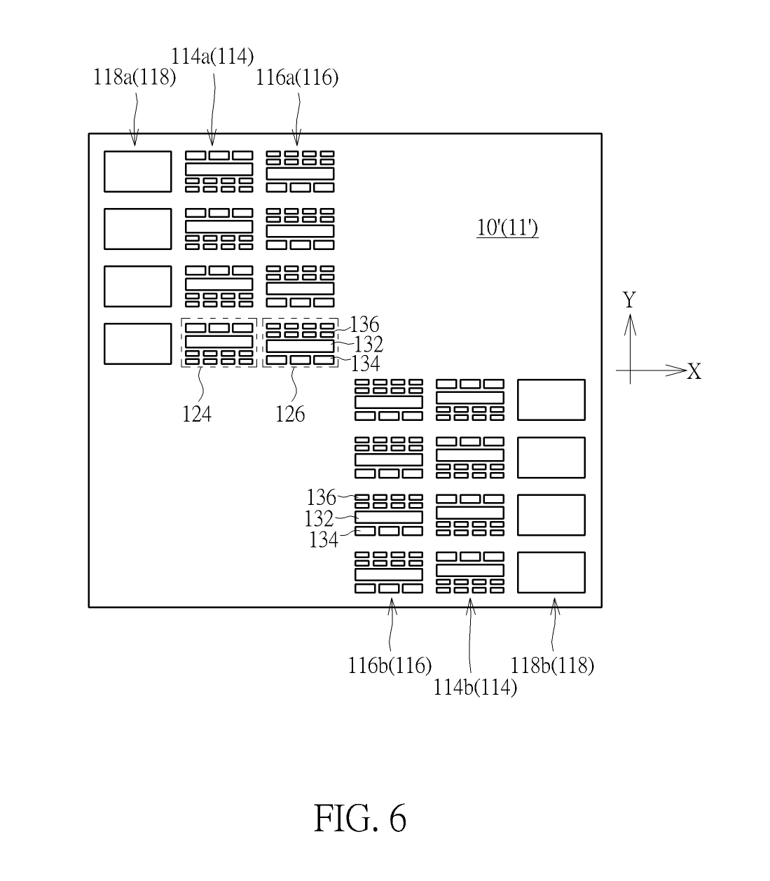

The second preferred embodiment of the present invention is shown in FIG. 6. In this embodiment, the overlay mark also includes at least a pair of first mark arrays 114 (labeled as 114a and 114b respectively), a pair of second mark arrays 116 (labeled as 116a and 116b respectively), and preferably further comprises a pair of third mark arrays 118 (labeled as 118a and 118b respectively). The first mark arrays 114a, 114b are disposed on a first photomask 10′, and the second mark arrays 116a, 116b are also disposed on the first photomask 10′ . The third mark arrays 118a, 118b are disposed on a second photomask 11′.

The difference between this embodiment and the first preferred embodiment is in this embodiment, each first mark array 114 and each second mark array 116 further comprises at least one dummy pattern 136, and preferably, the dummy pattern 136 may be disposed in each first mark unit 124 and in each second mark unit 126. Preferably, the first pattern 132 is disposed between the dummy pattern 136 and the second pattern 134, but not limited thereto. In addition, the first mark unit 124 and the second mark unit 126 with the dummy pattern 136 still satisfy the condition that the pattern of the first mark unit 124 is the same as the pattern of the second mark unit 126 after rotating 180 degrees (on XY plane). The dummy patterns 136 of this embodiment can be used for adjusting the optical proximity effect or the micro-loading effect. Other features of this embodiment are the same as the first preferred embodiment mentioned above, and will not be described again here.

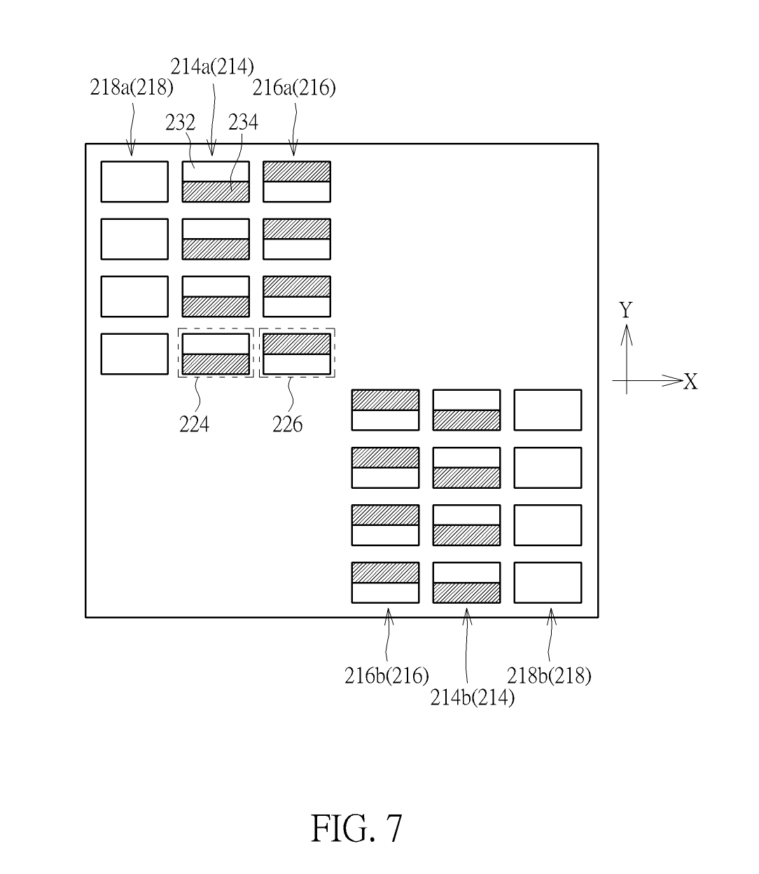

The third preferred embodiment is shown in FIG. 7. In this embodiment, the overlay mark comprises at least a pair of first mark arrays 214 (214a, 214b), a pair of second mark arrays 216 (216a, 216b), and preferably comprises a pair third mark arrays 218 (218a, 218b).

The first mark array 214 consists of a plurality of first mark units 224, and each first mark unit 224 consists of a first pattern 232 and a second pattern 234. The second mark array 216 consists of a plurality of second mark unit 226, and each second mark unit 226 also consists of the first pattern 232 and the second pattern 234. In addition, the pattern of each first mark unit 224 is the same as the pattern of each second overlay pattern 226 after rotating 180 degrees (on XY plane). The difference between this embodiment and the first preferred embodiment is that in this embodiment, the first patterns 232 and the second patterns 234 are formed through different photolithography processes, for example, each first pattern 232 is formed through a first photolithography process, and each second pattern 234 is formed through a second photolithography process. Therefore, each first pattern 232 can be formed through a first photomask (not shown), each second pattern 234 can be formed through a second photomask (not shown), and each third mark array 218 can be formed through a third photomask (not shown). The first patterns 232 and the second patterns 234 mentioned above will be formed on a same level of a semiconductor substrate when the first photolithography process and the second photolithography process are performed.

Similarly, the first pattern 232 and the second pattern 234 are formed through different photolithography processes with different photomasks. The first overlay pattern and the second overlay pattern may shift due to some errors occurring, but since the embodiment still satisfies the condition of the first overlay pattern 224 and the second overlay pattern 226 are upside down to each other (having same pattern after rotating 180 degrees), after the overlay mark information is generated, the first overlay patterns and the second overlays pattern will be shifted towards opposite directions. In this way, the bias value and real overlay value can be calculated by using the methods mentioned in the first preferred embodiment. Other features of this embodiment are the same as the first preferred embodiment mentioned above, and will not be described again here.

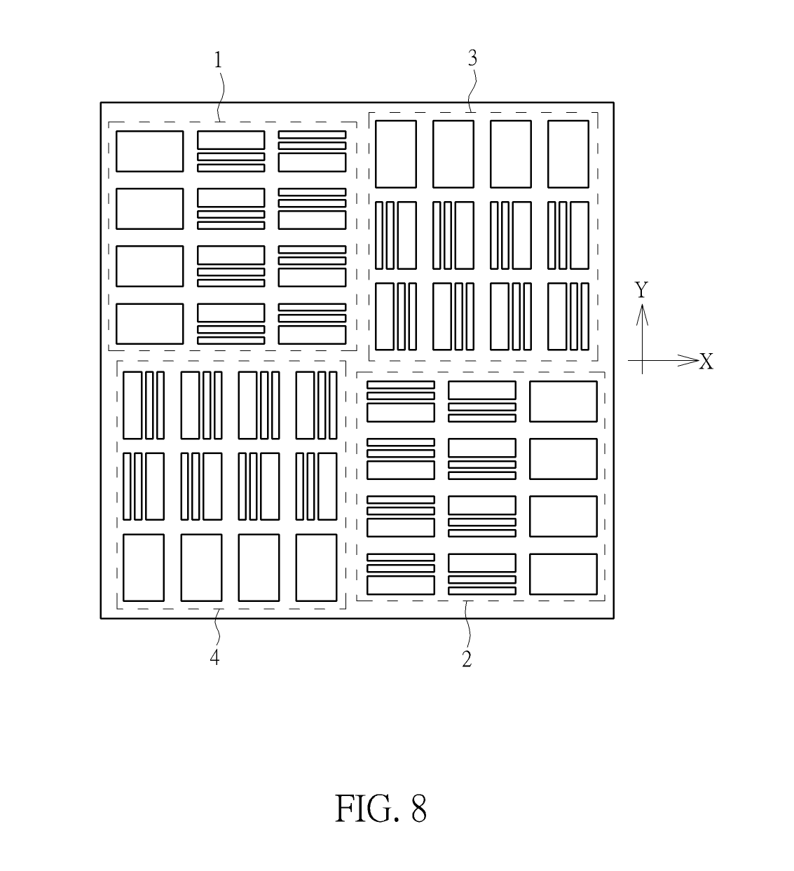

The overlay mark in each embodiment mentioned above is used for correcting the overlay errors along one direction (such as Y-axis) . However, the present invention also provides an overlay mark used for correcting the overlay errors along two different directions. As shown in FIG. 8, the overlay mark is substantially the same as the overlay mark shown in FIG. 1, but the overlay mark further comprises a third region 3 and a fourth region 4, and the overlay mark arrays within the third region 3 and the fourth region 4 are used for correcting overlay errors along X-axis direction. Similarly, the second preferred embodiment or the third embodiment of the present invention can combined with this embodiment. Other feature will not be described again.

In summary, the present invention provides an overlay mark and a method for correcting the overlay errors. The key feature is the first overlay pattern and the second overlay pattern are disposed within a same level, and the third overlay pattern disposed within another level. In addition, the pattern of the first overlay pattern is the same as the pattern of the second overlay pattern after rotating 180 degrees. After the inspection process is performed, since the first overlay pattern and the second overlay pattern are shifted toward opposite directions, the overlay errors caused by different boundary conditions can be calculated, and can achieve the purpose of correcting the overlay errors or making an alarm notification.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An overlay mark, comprising:
at least a pair of first overlay patterns disposed within a first layer, each first overlay pattern consisting of a plurality of first mark units and being arranged along a first direction, each first mark unit including a first pattern and at least one second pattern, the first pattern and the second pattern having different dimensions; and
at least a pair of second overlay patterns disposed within the first layer, each second overlay pattern consisting of a plurality of second mark units and being arranged along the first direction, wherein the pattern of each second mark unit is the same as the pattern of each first mark unit after rotating 180 degrees.

2. The overlay mark of claim 1, further comprising a pair of third overlay patterns disposed within a second layer, each third overlay pattern consisting of a plurality of third mark units and being arranged along the first direction.

3. The overlay mark of claim 1, wherein the first pattern of each first mark unit is a rectangle shaped structure, the first mark unit comprises a plurality of second patterns, and each second pattern is a grid structure.

4. The overlay mark of claim 3, wherein each of the second patterns is arranged parallel to each other.

5. The overlay mark of claim 4, wherein each first mark unit further comprises a plurality of the dummy patterns.

6. The overlay mark of claim 5, wherein each first pattern is disposed between the second pattern and the dummy pattern.

7. The overlay mark of claim 1, wherein each first mark unit consists of only one first pattern and only one second pattern.

8. The overlay mark of claim 7, wherein the first pattern is formed through a first photolithography process, and the second pattern is formed through a second photolithography process.

9. A method for measuring overlay, comprising:
detecting an overlay mark on a substrate, so as to generate an overlay mark information, wherein the overlay mark information comprises:
at least a pair of first overlay patterns disposed within a first layer, each first overlay pattern consisting of a plurality of first mark units and being arranged along a first direction, each first mark unit including a first pattern and at least one second pattern, the first pattern and the second pattern having different dimensions; and
at least a pair of second overlay patterns disposed within the first layer, each second overlay pattern consisting of a plurality of second mark units and being arranged along the first direction, wherein the pattern of each second mark unit is the same as the pattern of each first mark unit after rotating 180 degrees;
calculating the overlay mark information, so as to obtain a deviation value AB between the first overlay pattern and the second overlay pattern, wherein deviation value AB is the distance between a central position of the first overlay pattern and a central position of the second overlay pattern; and
using the deviation value AB to calculate a bias value, wherein the bias value is equal to AB/2.

10. The method of claim 9, wherein the method for obtaining the deviation value AB between the first overlay pattern and the second overlay pattern comprises:
obtaining the image file of the first overlay patterns, the image file of the first overlay patterns having a central position A;
obtaining the image file of the second overlay patterns, the image file of the second overlay patterns having a central position B; and
measuring the distance between the central position A and the central position B.

11. The method of claim 9, further comprising a pair of third overlay patterns disposed within a second layer, each third overlay pattern consisting of a plurality of third mark units and being arranged along the first direction.

12. The method of claim 11, further comprising:
obtaining a bias value AC between the first overlay pattern and the third overlay pattern;
obtaining a bias value BC between the second overlay pattern and the third overlay pattern; and
using the bias value AB and the bias value AC to calculate a real overlay value, wherein the real overlay value is equal to the average of (AC+BC).

13. The method of claim 12, wherein the method for obtaining the deviation value AC between the first overlay pattern and the third overlay pattern comprising:
obtaining the image file of the first overlay patterns, the image file of the first overlay patterns having a central position A;
obtaining the image file of the third overlay patterns, the image file of the third overlay patterns having a central position C; and
measuring the distance between the central position A and the central position C.

14. The method of claim 12, wherein the method for obtaining the deviation value BC between the second overlay pattern and the third overlay pattern comprises:
obtaining the image file of the second overlay patterns, the image file of the second overlay patterns having a central position B;
obtaining the image file of the third overlay patterns, the image file of the third overlay patterns having a central position C; and
measuring the distance between the central position B and the central position C.

15. A method for measuring overlay, comprising:
identifying a target pattern having features to be printed in a single layer of an integrated circuit device;
defining data for a pair of first overlay patterns, wherein each first overlay pattern consisting of a plurality of first mark units and being arranged along a first direction, each first mark unit including a first pattern and at least one second pattern, the first pattern and the second pattern having different dimensions;
defining data for a pair of second overlay pattern, wherein each second overlay pattern consisting of a plurality of second mark units and being arranged along the first direction, wherein the pattern of each second mark unit is the same as the pattern of each first mark unit after rotating 180 degrees;
calculating the data for the first and second overlay patterns for respectively causing portions of the target pattern;
determining a deviation value AB between the first overlay pattern and the second overlay pattern, wherein deviation value AB is the distance between a central position of the first overlay pattern and a central position of the second overlay pattern; and
using the deviation value AB to calculate a bias value, wherein the bias value is equal to AB/2.

16. The method of claim 15, wherein the first overlay patterns is formed through a first exposure process.

17. The method of claim 15, wherein the second overlay patterns is formed through a second exposure process.

18. The method of claim 15, further comprising outputting the bias value after the bias value is calculated.

19. The method of claim 18, further comprising performing a process for judging whether the bias value is larger than a specific value or smaller than the specific value.

20. The method of claim 19, after the process for judging the bias value is performed, further comprising checking or stopping at least one of the photolithography, etching, deposition, thermal/annealing process and planarization tools while the bias value is larger than the specific value.
